(19) United States
(12) Patent Application Publication
(10) Pub. No.: US 2008/0055534 A1
(43) Pub. Date: Mar. 6, 2008

(54) Back light unit and liquid crystal display device using the same

(75) Inventor: Tetsunori Kawano, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kanagawa (JP)

(21) Appl. No.: 11/892,744

(22) Filed: Aug. 27, 2007

(30) Foreign Application Priority Data
Aug. 30, 2006 (JP) 233258/2006

(51) Int. Cl. G02F 1/1333; B60Q 1/06

(52) U.S. Cl. 349/161; 362/373

(57) ABSTRACT

A substrate on which light emitting diodes (LEDs) of a back light unit is mounted is fixed to a heat sink without using a screw. A groove having an inverse tapered inner side wall is provided in a heat sink, and a substrate on which LEDs are mounted is stored in the groove. When the LEDs are turned on, the substrate expands due to thermal expansion to contact with the side wall of the groove, and can be fixed to the groove without using screws.

This application is based upon and claims the benefit of priority from Japanese patent application No. 2006-233258, filed on Aug. 30, 2006, the disclosure of which is incorporated herein in its entirety by reference.

### BACKGROUND OF THE INVENTION

1. Field of the Invention

A present invention relates to a back light unit and a liquid crystal display (LCD) device using the same, and particularly relates to a fitting structure for light emitting diodes (LEDs) to a heat sink of a back light unit using LEDs as a light source, and the LCD device using the same.

2. Description of the Related Art

A cold cathode fluorescent tube, for example disclosed in Japanese Patent Application Laid-Open No. 2002-311417 (patent document 1) is used for a light source of an LCD device.

There are a vertical light type back light and a side light type back light as a light source for an LCD device using a cold cathode tube. And in the LCD device with the vertical light type back light, the cold cathode fluorescent tube is arranged at a back side of the LCD panel. An image is displayed when white light emitted from the cold cathode fluorescent tube is transmitted to the LCD panel.

In an LCD device with a side light type back light, a cold cathode fluorescent tube is arranged to a side on the back of the LCD panel. A white light emitted from the cold cathode fluorescent tube is supplied to all over the LCD panel via a light guide plate, and an image is displayed when the light is transmitted to the LCD panel.

On the other hand, in order to improve the color reproducibility of the image, a backlight unit using LEDs as a light source such as red LED, green LED and blue LED is disclosed in Japanese Patent Application Laid-Open No. 2005-38771 (patent document 2) and Japanese Patent Application Laid-Open No. 2006-18175 (patent document 3). In the backlight unit, a plurality of red LEDs, green LEDs and blue LEDs are arranged in a line behind an LCD panel. An optical guide or a light guide plate mixes three color lights emitted from those LEDs to make a white light. The white light is irradiated to the LCD panel. These LEDs are usually mounted on a circuit board using such substrate as a glass epoxy substrate, a ceramic substrate, or a metal substrate (e.g. aluminum) to provide an LED-substrate. Since LEDs generate heat, the LED-substrate is fixed to a heat sink to prevent the thermal damage for the LEDs.

FIG. 1 is an example of an LCD device disclosed by the patent document 3. An LCD device 100 in FIG. 1 includes a backlight unit 200 and an LED-substrate 105. The backlight unit 200 includes a heat sink 102 made of metal such as aluminum. The LED-substrate 105 is made of an elongated substrate 105A on which a plurality of LEDs 105B as light sources are arranged in a line along a longitudinal direction of the substrate 105A. The LED-substrate 105 is fixed to a heat sink 102 by using screws 116.

A backlight unit 200 further includes a heat radiation member 103 to the heat sink 102. The radiation member 103 includes a base plate 103A and a plurality of heat radiation fins 103B extending from the base plate 103A. The fins 103B are arranged in a matrix shape on a rear surface of the base plate 103A. The base plate 103A is fixed to the heat sink 102 by using a plurality of screws 121 and nuts 122.

On the other hand, a rear cover 104 of the LCD module is provided in front of the heat sink 102. The rear cover 104 is divided into two parts so as to provide an aperture 117 therebetween. Emitted lights from the LED 105B are bent by a reflector 106 so as to enter a first light guide plate for color mixture, or color-mixing plate 107. The reflector 108 reflects the light which is emitted from the color-mixing plate 107. In front of the color-mixing plate 107, a second light guide plate for illumination, or an illuminating plate 109 is provided in parallel with the light guide plate 107. The light reflected by the reflector 108 enters the illuminating plate 109. A reflective sheet 110 is disposed between those plates 107 and 109 so as to prevent light leakage from a gap between those plates 107 and 109. An optical sheet 111 is disposed between the illuminating plate 109 and a LCD panel 113.

The color-mixing plate 107, the reflector 108, the reflective sheet 110, the illuminating plate 109, the optical sheet 111, and the LCD panel 113 are housed in a frame shape chassis 112. The chassis 112 is arranged outside a rear cover 104. A front cover 114 is provided to hold the LCD panel 113.

In the back light unit 200 shown in FIG. 1, the LED-substrate 105 is fixed to the heat sink 102 with the screws. However, in such structure, the number of the screws for fixing the LED-substrate 105 to a heat sink increases when lengthening the LED-substrate. Therefore, a handling time for fixing the LED-substrate to the heat sink increases.

### SUMMARY OF THE INVENTION

An exemplary feature of the present invention provides a back light unit having a structure that a substrate on which a light emitting diode is mounted is fixed on a heat sink without using screws, and an LCD device using the back light unit.

A back light unit of an exemplary aspect of the present invention includes a substrate on which a light emitting diode is mounted and a heat sink for radiating heat generated from the light emitting diode, wherein the heat sink includes a groove including a reversely tapered side wall therein and the substrate is disposed therein.

An LCD device of an exemplary aspect of the present invention includes an LCD panel and a light equipment which illuminates the LCD panel, wherein the light equipment includes a substrate on which a light emitting diode is mounted, and a heat sink for radiating heat generated from the light emitting diode, and wherein the heat sink includes a groove including a reversely tapered side wall therein and the substrate is disposed in the groove.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The above and other objects, features and advantages of the present invention will become more apparent from the following detailed description when taken in conjunction with the accompanying drawings wherein:

FIG. 1 is a sectional view showing a structure of an LCD device provided with a back light unit;

FIG. 2 is a sectional view showing a structure of a back light unit of an exemplary embodiment of the present invention;

FIG. 3 is a top view showing a structure of the back light unit of FIG. 2;

FIG. 4 is a top view showing a structure of an LED-substrate of the back light unit of FIG. 2;

FIG. 5A is a top view before equipping with a holding spring the groove formed in a first heat sink of FIG. 2;

FIG. 5B is a top view showing a state where an LED-substrate was stored after equipping with a holding spring the groove formed in the first heat sink of FIG. 2;

FIG. 6A is a sectional view showing a back light unit having LEDs turned off of an exemplary embodiment of the present invention;

FIG. 6B is a sectional view showing a back light unit having LEDs turned on of an exemplary embodiment of the present invention;

FIG. 7 is a sectional view showing an example of an LCD device having a back light unit of an exemplary embodiment of the present invention;

FIG. 8 is a sectional view showing another example of an LCD device having a back light unit of an exemplary embodiment of the present invention; and

FIG. 9 is a sectional view showing another example of the substrate structure of the LED-substrate of a back light unit of an exemplary embodiment of the present invention.

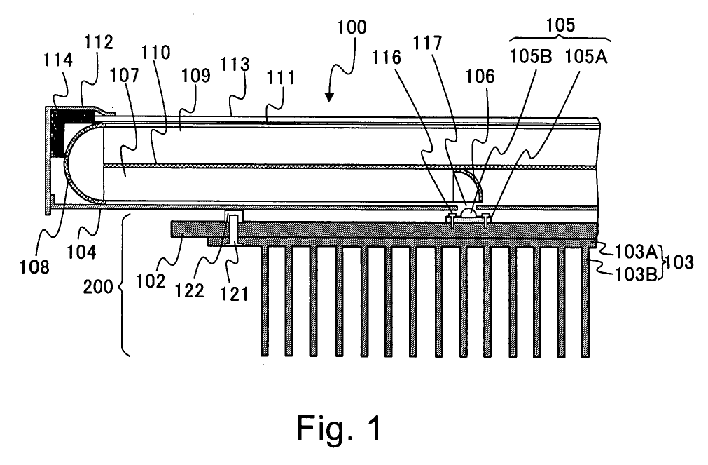

### DETAILED DESCRIPTION OF THE EXEMPLARY EMBODIMENTS

Exemplary embodiments of the present invention will now be described in detail in accordance with the accompanying drawings.

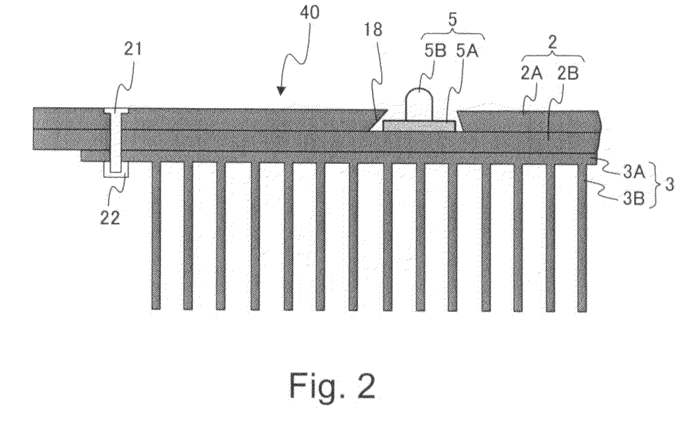

As shown in FIG. 2, a back light unit 40 according to an exemplary embodiment of the present invention is provided with an LED-substrate 5, a heat sink 2 having a reversely tapered groove 18 which is formed in a surface thereof, and a heat radiation member 3 provided on the other surface of the heat sink 2. The LED-substrate 5 is housed inside the groove 18 of the heat sink 2. The groove 18 includes inner side walls which face each other and are located along a longitudinal direction thereof. The reversely tapered groove is further defined as a groove having a cross-section, orthogonal to the longitudinal direction, in which an opening width of the groove gradually becomes wider toward a bottom of the groove. On the other hand, a forward tapered groove may be defined as a groove having a cross-section in which the opening width of the forward tapered groove becomes gradually narrower toward the bottom thereof.

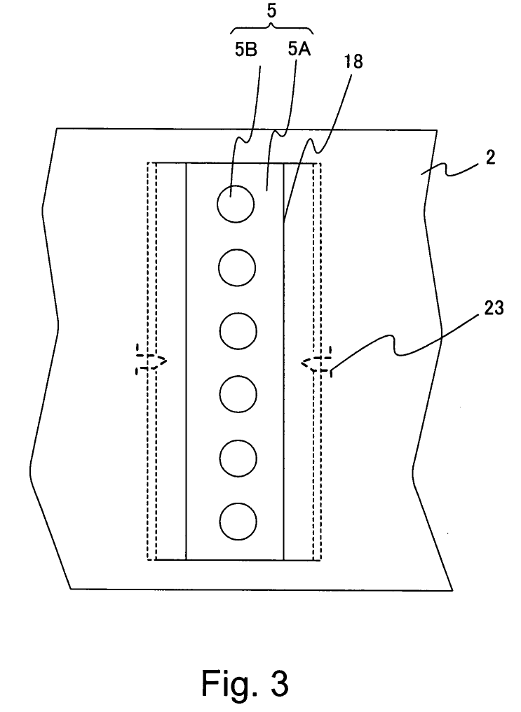

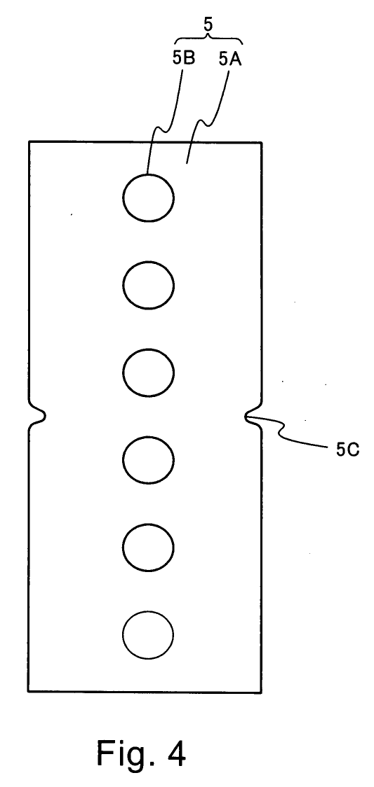

The LED-substrate 5 includes an elongated substrate 5A and a plurality of LEDs 5B mounted thereon, as shown in FIG. 4. Concave portions 5C are formed in both sides of the substrate 5A of the LED-substrate 5. And as shown in FIG. 3, the LED-substrate 5 is arranged in the groove 18 so that each part of a pair of holding springs 23 disposed in a groove formed on a surface of the heat sink 2 may fit into the concave portion 5C of the substrate 5A. When the concave portion 5C is held, at both sides thereof, with the holding springs 23, the substrate 5A is fixed at a predetermined position in the groove 18.

In the back light unit of the exemplary embodiment, the LED-substrate 5 is only fixed to the heat sink 2 with the holding springs 23. A well known fixing means like a screw is not used in the back light unit in the exemplary embodiment. Therefore, even if the substrate 5A of the LED-substrate 5 is long, a handling time for fixing the substrate 5A to the heat sink 2 can be reduced. As shown in FIG. 2, a heat radiation member 3 consists of a base plate 3A and a plurality of heat radiation fins 3B extending from the base plate 3A. The fins 3B are arranged in a matrix shape on a rear surface of the base plate 3A. The base plate 3A is fixed to the heat sink 2 by using a plurality of screws 21. The screws 21 are fixed with the nuts 22. Accordingly, the heat radiation member 3 is stuck to the heat sink 2. The substrate 5A of the LED-substrate 5 is made of either a glass epoxy substrate, a metal plate such as aluminum, or a ceramic substrate. The heat sink 2 and the heat radiation member 3 are made of such a metal plate selected from a steel plate, an aluminum plate and a stainless steel plate.

Next, a method for forming the groove 18 with a reversely tapered shape of the heat sink 2 is described below. The heat sink 2 is formed of two heat sinks (a first heat sink 2A and a second heat sink 2B as shown in FIG. 2, for example). An opening which includes a forward tapered side wall is formed in the first heat sink 2A by using process of either cutting, metallic mold processing, or etching. After forming the opening having a forward tapered side wall, a groove for installing the holding springs 23 are formed on a surface of the first heat sink 2A on which the second heat sink 2B is attached. The groove is formed so as to link the opening. Next the first heat sink 2A is turned over, and put on the second heat sink 2B. The reversed first heat sink 2A and the second heat sink 2B which are piled up are fixed by screwing or the like.

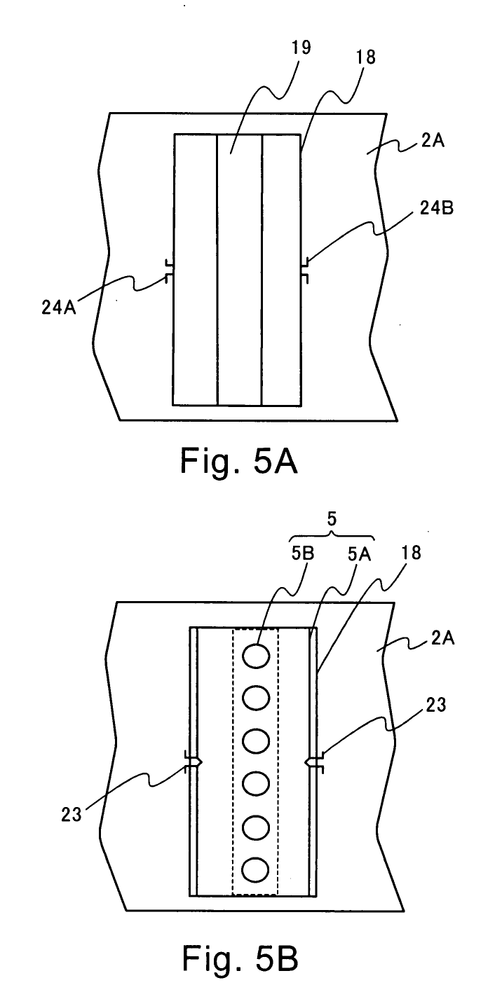

FIG. 5A shows, as an example, a surface of the first heat sink 2A having the groove 18, an opening 19 thereof, and grooves 24A and 24B for holding springs. FIG. 5B shows, as an example, the surface of the first heat sink 2A in which the LED-substrate 5 is housed in the groove 18 of the first sink 2A and is fixed, by the holding springs 23, at a predetermined position in the groove 18.

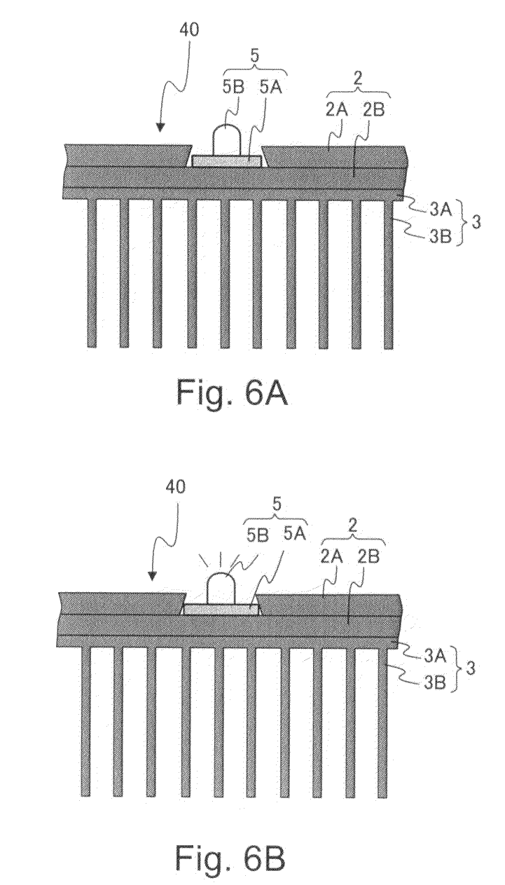

FIGS. 6A and 6B shows configurations of the backlight unit of the exemplary embodiment. Referring to FIG. 6A, when the LEDs 5B are turned off, the substrate 5A of the LED-substrate 5 does not touch an inner side wall of the groove 18. Referring to FIG. 6B, when the LEDs 5B are turned on, the substrate 5A expands to touch the inner side walls thereof due to generated heat from the LEDs 5B. Therefore, the substrate 5A is fixed by both of the side walls and the holding springs 23 disposed in the grooves 24A and 24B in the groove 18. It is desirable to adjust a size of the groove 18 and the opening 19 thereof such that the substrate 5A expands to touch the inner side wall of the groove 18 when the LEDs 5B are tuned on. Further, in order to increase a contact area between the side face of the substrate 5A and the inner side wall of the groove 18 when the substrate 5A expands, a part of the side face thereof may be formed in a tapered shape.

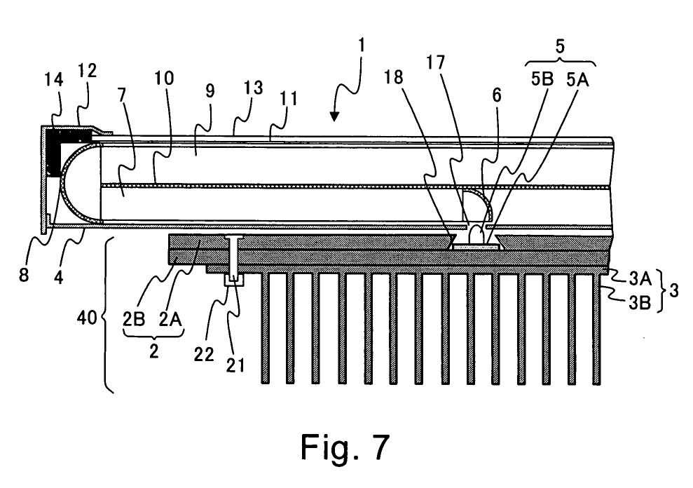

FIG. 7 shows a first example of an LCD device having the back light unit of the exemplary embodiment of the present invention. An LCD device 1 includes a back light unit 40. The back light unit 40 includes an LED-substrate 5, a heat sink 2 having a reversely tapered groove 18 in the surface thereof, and a heat radiation member 3 provided on a surface of the heat sink 2. The LED-substrate 5 is housed in the groove 18 of the heat sink 2. The heat sink 2 is made of a metal material such as aluminum. The heat sink 2 includes a layered structure having a first heat sink 2A and a second heat sink 2B. The heat radiation member 3 includes a plate-like base plate 3A and a plurality of heat radiation fins 3B extending from the base plate 3A. The fins 3B are arranged, in a matrix shape, on a rear surface of the base plate 3A. The base plate 3A of the heat radiation member 3 is connected with the heat sink 2 by using a plurality of screws 21 and nuts 22. Accordingly, the heat radiation member 3 is stuck to the heat sink 2.

A rear cover 4 is provided in front of the heat sink 2 of the back light unit 40. The rear cover 4 is divided into two parts and an aperture 17 is arranged therebetween. A plurality of LEDs 5B is arranged, in a line, along the aperture 17 of the rear cover 4. The LED-substrate 5 includes a substrate 5A and a plurality of LEDs 5B mounted thereon. The substrate 5A is an elongated plate-like member on which the LEDs 5B are arranged in a line along an elongated direction. The LEDs 5B are used as light sources of the LCD device 1.

A reflector 6 is located in front of the LEDs 5B. The reflector 6 reflects the light and changes a direction thereof. The lights emitted from the LEDs 5B enter the reflector 6, and are reflected towards a side of the LCD device 1. The lights reflected from the reflector 6 enter a first light guide plate for color mixture, or color-mixing plate 7. A reflector 8 is disposed on a side opposite to the reflector 6 via the color-mixing plate 7. The reflector 8 reflects the lights which are emitted from the light guide plate for color mixture 7. In front of the color-mixing plate 7, a second light guide plate for illumination, or illuminating plate 9 is provided in parallel with the color-mixing plate 7. The light reflected with the reflector 8 enters the illuminating plate 9. A reflective sheet 10 is disposed between the color-mixing plate 7 and the illuminating plate 9 to prevent light leakage. An optical sheet 11 is provided in front of the illuminating plate 9. The color-mixing plate 7, the reflector 8, the reflective sheet 10, the illuminating plate 9 and the optical sheet 11 are housed in a frame-like chassis 12. The chassis 12 is arranged outside a rear cover 4. The color-mixing plate 7, the reflective sheet 10, the illuminating plate 9, and the optical sheet 11 are held with the chassis 12 and the rear cover 4. A front cover 14 is arranged around the LCD panel 13. Thereby, the LCD panel 13 is held with the front cover 14 and the chassis 12.

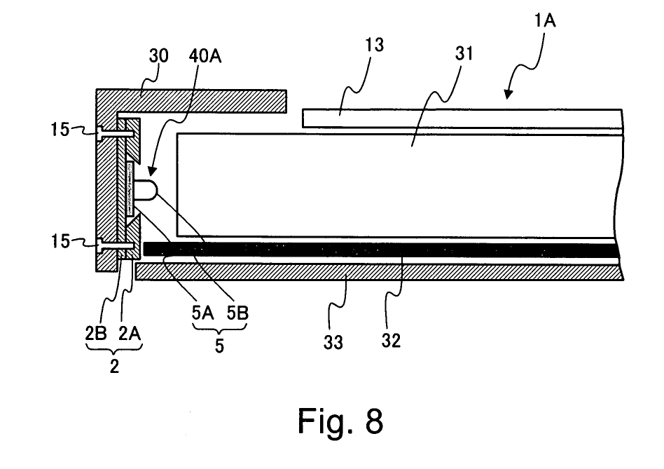

FIG. 8 shows a second example of an LCD device having the back light unit of the exemplary embodiment of the present invention. The LCD device includes an LCD panel 13, a light guide plate 31, a light reflector 32 and a rear cover 33. An LED-substrate 5 of a back light unit 40A and a heat sink 2 which are shown in FIG. 8 are the same as that of FIG. 7. The LED-substrate 5 is housed in a reversely tapered groove 18 of a heat sink 2, and the heat sink 2 is fixed to an inner face of a front cover 30 with screws 15. The LED-substrate 5 includes a substrate 5A and a plurality of LEDs 5B mounted thereon. The LED-substrate 5 is used as a light source of an LCD device 1A. The generated heat from LEDs 5B is transferred to the front cover 30 via the substrate 5A and heat sink 2, and to be radiated.

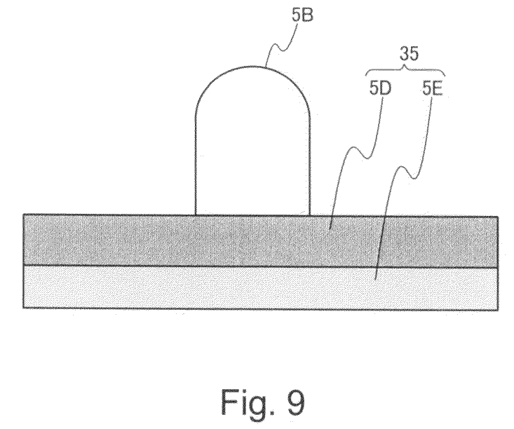

In the back light unit of the exemplary embodiment of the above-mentioned present invention, the substrate 5A of the LED-substrate 5 may includes a plurality of substrates which are laminated. Each of the substrates has different coefficient of thermal expansion. FIG. 9 shows that the LEDs 5B are mounted on a multilayer substrate 35 including a first substrate 5E made of an organic material and a second substrate 5D made of a metal which has a coefficient of thermal expansion smaller than that of the first substrate 5E. For example, the first substrate 5E may include epoxy resin, and the second substrate 5D may include aluminum. In such configuration, since thermal expansion of the first substrate 5E becomes larger than that of the second substrate 5D, the multilayer substrate 35 is curved downwardly (i.e. convex downward) when the LEDs 5B are turned on. However, since both edges of a second substrate 5D touch the inner side walls of the groove 18, the multilayer substrate 35 hardly curves. The first substrate 5E strongly sticks to the heat sink 2B instead. When the LEDs 5B are turned on, temperature of an upper surface of the substrate 5 on which the LEDs 5B are disposed becomes larger than that of a bottom surface thereof. If the substrate 5 includes only one substrate, a gap may occur between the bottom surface and the heat sink 2B.

Other than the above embodiments, the epoxy resin may include carbon therein to enhance thermal conductivity.

Only one holding spring 23 may be employed in order to fix the substrate 5 in the groove 18. Further, only one of the inner side walls may be formed in a tapered manner rather than both side walls as in the exemplary embodiments.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A back light unit comprising:
a substrate on which a light emitting diode is mounted; and
a heat sink for transferring heat which is generated from the light emitting diode,
wherein the heat sink includes a groove provided with a reversely tapered side wall therein and the substrate is disposed therein.

2. The backlight unit according to claim 1, wherein a projecting part is disposed in the side wall, a concave portion is formed in a side face of the substrate, and the projecting part is set in the concave portion such that the substrate is positioned inside the groove.

3. The backlight unit according to claim 1, further comprising; a heat radiating fin mounted to the heat sink.

4. The backlight unit according to claim 1, wherein the substrate includes a plurality of layered substrates which differ in a coefficient of thermal expansion, and the coefficient of thermal expansion of a lower substrate which contacts the heat sink is greater than that of an upper substrate.

5. The backlight unit according to claim 4, wherein the lower substrate includes an organic member and the upper substrate includes a metal member.

6. The backlight unit according to claim 1, wherein a part of the substrate contacts the side wall of the groove when the light emitting diode is turned on, and a gap is formed between the substrate and the side wall thereof when the light emitting diode is turned off.

7. A liquid crystal display device comprising:
a liquid crystal display panel; and
a light equipment which illuminates the liquid crystal panel, wherein
the light equipment includes a substrate on which a light emitting diode is mounted, and a heat sink for radiating heat from the light emitting diode, and wherein the heat sink includes a groove provided with a reversely tapered side wall therein and the substrate is disposed in the groove.

8. The liquid crystal display device according to claim 7, further comprising a projecting part disposed in the side wall, wherein a concave portion is formed in a side face of the substrate, and the projecting part is set in the concave portion such that the substrate is positioned inside the groove.

9. The liquid crystal display device according to claim 7, wherein the heat sink is provided with a heat radiating fin.

10. The liquid crystal display device according to claim 7, wherein the substrate includes a plurality of layered substrates which differ in a coefficient of thermal expansion, and wherein a coefficient of thermal expansion of a lower substrate which contacts the heat sink is greater than that of an upper substrate.

11. The liquid crystal display device according to claim 10, wherein the lower substrate includes an organic member and the upper substrate includes a metal member.

12. The liquid crystal display device according to claim 7, wherein a part of the substrate contacts the side wall of the groove when the light emitting diode is turned on, and a gap is formed between the substrate and the side wall of the groove when the light emitting diode is turned off.
